(19) United States
(12) Patent Application Publication
(10) Pub. No.: US 2008/0228716 A1
(43) Pub. Date: Sep. 18, 2008

(54) SYSTEM AND METHOD FOR ACCESSING UNSTRUCTURED DATA USING A STRUCTURED DATABASE QUERY ENVIRONMENT

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/685,327

(22) Filed: Mar. 13, 2007

(51) Int. Cl. G06F 17/30

(52) U.S. Cl. 707/3; 707/E17.014

(57) ABSTRACT

Method, system and article of manufacture for processing database queries and, more particularly, for executing queries to retrieve data from both structured and unstructured data sources. A method of retrieving data from a database and an unstructured data source includes accessing the database to retrieve a first structured result set, accessing the unstructured data source using at least a portion of the structured data included in the first structured result set to retrieve an unstructured data result set, and generating a second structured result set from the unstructured data result set; and storing the second structured result in the database.

### BACKGROUND OF THE INVENTION

1. Field of the Invention

The present invention generally relates to processing database queries and, more particularly, to executing queries to retrieve data from both structured and unstructured data sources.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and users, can issue queries against data in a database. Queries may be predefined (i.e., hard coded as part of an application) or may be generated in response to input (e.g., user input). Upon execution of a query against a database, a result set is returned to the requesting entity.

However, one difficulty in executing queries is that the data against which a query is evaluated needs to be included within a database. For instance, assume a query configured to retrieve information about patients in a hospital, such as established diagnoses and Uniform Resource Locators (URLs) to documents related to the established diagnoses. Assume further that an underlying database includes a database table having an established diagnosis for each patient, but that the database does not include the requested URLs. Because the query references data not contained in an underlying database table (specifically, the URLs to the related documents), this query cannot be run against this database.

Assume now that the related documents are included with an external unstructured data source and that the requested URLs can be identified by running a search on this data source (i.e., by performing a keyword search using an Internet search engine). In this case, the requested URLs need to be retrieved from the unstructured data source and included with the underlying database to allow the query to be executed.

However, the unstructured data source may contain documents related to a large amount of different diagnoses and only specific diagnoses representing a small portion of the different diagnoses, such as 5%, may be available for the patients in the hospital. Further, the specific diagnoses may be unknown prior to execution of the given query against the underlying database. Thus, to execute this query, URLs for documents related to each of the different diagnoses needs to be retrieved from the unstructured data source and included with the underlying database. However, in the given example, running a search on the unstructured data source to identify documents related to each of the different diagnoses is inefficient and wastes processor and storage resources.

Therefore, there is a need for an efficient technique for executing queries requesting data from a database and an unstructured data source.

### SUMMARY OF THE INVENTION

The present invention is generally directed to a method, system and article of manufacture for processing database queries and, more particularly, for executing queries to retrieve data from both structured and unstructured data sources.

One embodiment of the invention includes a computer-implemented method of retrieving data from a database and an unstructured data source. The method generally includes accessing the database to retrieve a first structured result set, and accessing the unstructured data source using at least a portion of the structured data included in the first structured result set to retrieve an unstructured data result set. The method also includes generating a second structured result set from the unstructured data result set and storing the second structured result set, wherein the second structured result set is available for further query processing. Another embodiment of the invention includes a computer-readable storage medium containing a program which, when executed by a processor, performs an operation for retrieving data from a database and an unstructured data source. The operation generally includes accessing the database to retrieve a first structured result set and accessing the unstructured data source using at least a portion of the structured data included in the first structured result set to retrieve an unstructured data result set. The operation also includes generating a second structured result set from the unstructured data result set and storing the second structured result set, wherein the second structured result set is available for further query processing.

Still another embodiment of the invention includes a system having a processor; and a memory containing a program. When executed by the processor, the program is generally configure to, in response to receiving a database query for execution, access a database to retrieve a first structured result set and access an unstructured data source using at least a portion of the structured data included in the first structured result set to retrieve an unstructured data result set. The program may further be configured to generate a second structured result set from the unstructured data result set, and store the second structured result set, wherein the second structured result set is available for further query processing.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to create and execute database queries against a database and an external unstructured data source, according to one embodiment of the invention;

FIGS. 3A-B are relational views of software components in one embodiment;

FIGS. 4-5 are flow charts illustrating the operation of a runtime component, in one embodiment; and

FIG. 6 is a flow chart illustrating a method of executing queries to retrieve data from both structured and unstructured data sources according to one embodiment of the invention.

### DETAILED DESCRIPTION OF THE PREFERRED EMBODIMENTS

### Introduction

The present invention is generally directed to a method, system and article of manufacture for processing database queries and, more particularly, for executing queries to retrieve data from both structured and unstructured data sources. In general, queries are executed against one or more underlying databases having structured data. Typically, a query includes at least one result field specifying what data elements should be returned in a result set and conditions used to evaluate whether a given element of data should be included in the result set.

In one embodiment, a query is received from a requesting entity. The query is configured to access an underlying database having structured data and an unstructured data source having unstructured data that is not included with the database. However, what unstructured data needs to be retrieved from the unstructured data source may depend on what structured data is retrieved using the query. For example, a researcher may desire to query a structured database to identify a group of patients meeting certain demographic criteria (e.g., age and gender), and for the patients retrieve what medical diagnoses have been made, as reflected by a diagnosis code (e.g., an ICD 9 code). Such data may be stored in a structured data source, such as a relational database, as a set of tables, columns, and records. Assume that the researcher also wishes to have the search results augmented with unstructured data, e.g. articles about the medical conditions represented by the diagnosis code available from pubmed or other search engine. Until the diagnosis codes are identified from the structured data source, what keywords to supply to the search engine (i.e., the unstructured data source), are not known.

Accordingly, a query may be executed to retrieve structured data from the underlying database (e.g., a set of data records stored in a relational database) and the results are used to access the unstructured data source (e.g., as a set of keywords supplied to a search engine) to identify unstructured data to return as part of the query results. Using the unstructured data, a structured result set is generated and linked with information from the structured database. More specifically, in one embodiment, a database query configured to identify structured data from the underlying database is generated based on the received query. This query is executed against the underlying database to create a first temporary structured result set. This result set is then used to access the unstructured data source. Using unstructured data retrieved from the unstructured data source, a second temporary result set is created and linked to the underlying database. The received query is then executed against the database and the linked structured result set to obtain a query result. The query result is returned to the requesting entity.

In one embodiment, the underlying database may be accessed using one or more data abstraction models that abstractly describe physical data in the underlying database. Using a data abstraction model, abstract queries may be constructed regardless of the structure or representation used by the underlying physical database. An abstract query may also include a request for data from the unstructured data source that is not described by the data abstraction model. The data abstraction model may be used to generate an executable query from the abstract query in a form consistent with a physical representation of the data in the underlying database.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention may be implemented as one or more software programs for use with a computer system. The program(s) include instructions for performing embodiments of the invention (including the methods described herein) and may be stored on a variety of computer-readable media. Examples computer-readable media include, but are not limited to: (i) non-writable storage media on which information is permanently stored (e.g., read-only memory devices within a computer such as CD-ROM or DVD-ROM disks readable by a CD-ROM or DVD-ROM drive) and/or (ii) writable storage media on which alterable information is stored (e.g., floppy disks within a diskette drive, hard-disk drives, or flash memory devices). Other media include communications media through which information is conveyed to a computer, such as a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

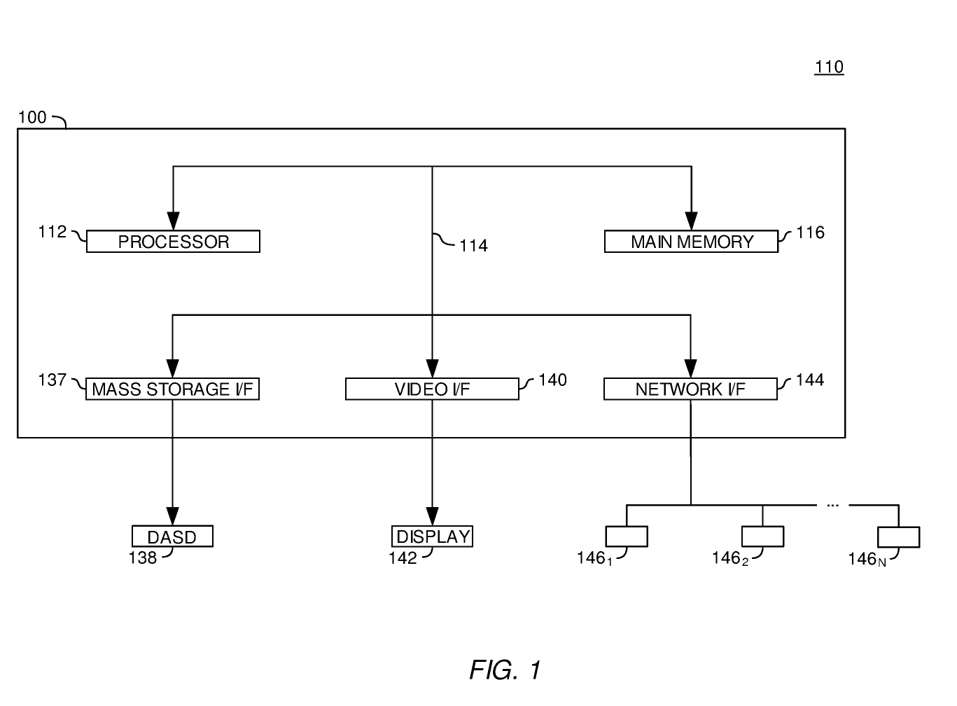

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to a plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Database and Query Environment

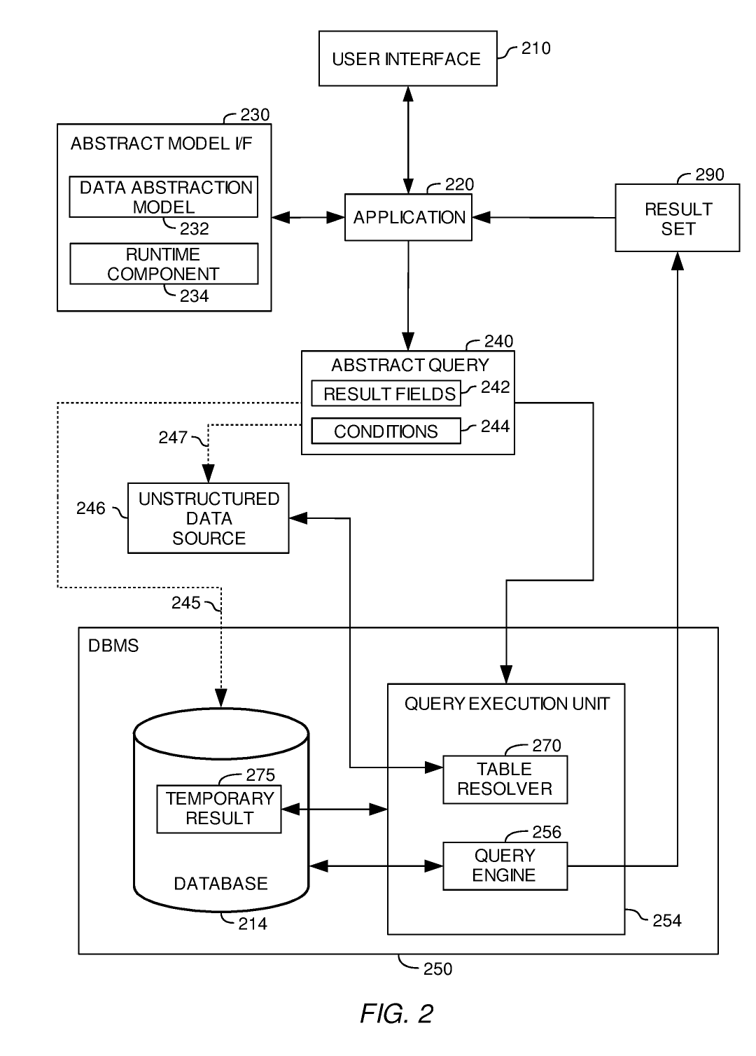

FIG. 2 illustrates a relational view of software components, according to one embodiment of the invention. As shown, the software components include a user interface 210, a DBMS 250, one or more unstructured data sources 246 (only one data source is illustrated for simplicity), one or more applications 220 (only one application is illustrated for simplicity) and an abstract model interface 230. The abstract model interface 230 provides an interface to a data abstraction model 232 and a runtime component 234. The DBMS 250 includes a database 214 and a query execution unit 254 having a query engine 256 and an instance of a table resolver object 270.

According to one aspect, the application 220 (and more generally, any requesting entity) submits queries evaluated using data from database 214 and unstructured data source 246. The database 214 is shown as a single database for simplicity. However, a given query can be executed against multiple databases which can be distributed relative to one another. Moreover, one or more databases can be distributed to one or more networked devices (e.g., networked devices 146 of FIG. 1). The database 214 is representative of any collection of data regardless of the particular physical representation of the data. A physical representation of data defines an organizational schema of the data. By way of illustration, the database 214 may be organized according to a relational schema (accessible by SQL queries) or according to an XML schema (accessible by XML queries). However, the invention is not limited to a particular schema and contemplates extension to schemas presently unknown. As used herein, the term “schema” refers to a particular arrangement of data.

In one embodiment, the unstructured data source 246 contains data that is related to, but not included with the database 214. By way of example, the unstructured data source 246 may be a document repository including one or more documents having a relationship to data in the database 214. For instance, assume that the database 214 contains a database table having an established diagnosis for each patient of a given hospital. In such a case, the unstructured data source 246 may contain documents that are related to one or more of the established diagnoses. In other words, the documents included with the unstructured data source 246 are related to the established patient diagnoses included with the database 214, but not included therewith.

In one embodiment, data in the unstructured data source 246 is defined by metadata associated with the data in the database 214. Furthermore, the data in the unstructured data source 246 can be defined by metadata associated with unstructured data such as documents that are referenced by URLs, for example. However, the type of the data and whether or not the data in the unstructured data source 246 relates to the data in the database 214 is not limiting of the invention. Instead, various types of data included with the unstructured data source 246 are broadly contemplated. For instance, assume that the unstructured data source 246 is associated with the data in the database 214 only by means of an issued query. For example, the unstructured data source 246 may have data related to specialists in different medical domains arranged by the geographic area where a given specialist practices. In this case, the issued query can request data for patients living in a given city and having a particular disease, as well as for a specialist practicing in the area of residence of such patients. Thus, the information about the specialists is linked to the patient information only viz a viz the query requesting both types of information All such implementations are broadly contemplated.

The queries issued by the application 220 may be predefined (i.e., hard coded as part of the application 220) or may be generated in response to input (e.g., user input). In one embodiment, the queries issued by the application 220 can be created by users using the user interface 210, which can be any suitable user interface configured to create/submit queries. According to one aspect, the user interface 210 is a graphical user interface. Note, however, the user interface 210 is shown by way of example; any suitable requesting entity may create and submit queries against the database 214 (e.g., the application 220, an operating system or an end user). Accordingly, all such implementations are broadly contemplated.

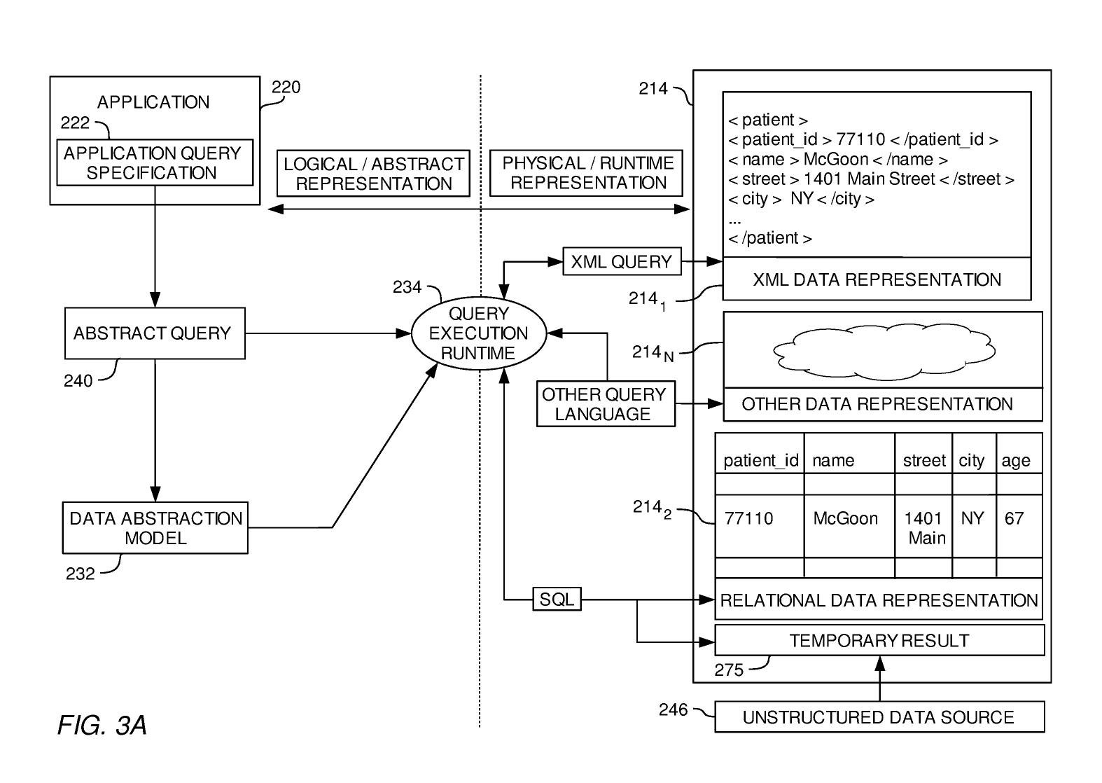

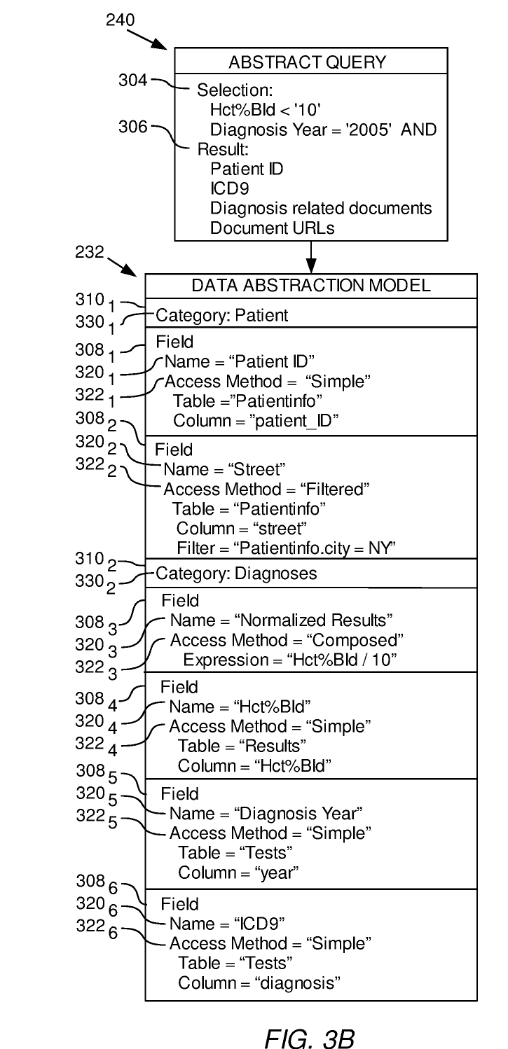

In one embodiment, the queries issued by the application 220 are composed using the abstract model interface 230. In other words, the queries are composed from logical fields provided by the data abstraction model 232 and translated by the runtime component 234 into a concrete (i.e., executable) query for execution. Such queries are referred to herein as “abstract queries”. An exemplary abstract model interface is described below with reference to FIGS. 3A-5.

Illustratively, the application 220 issues an abstract query 240 that requests data from the database 214, as illustrated by a dashed arrow 245, and data from the unstructured data source 246, as illustrated by a dashed arrow 247. For instance, assume that the abstract query 240 requests patient identifiers and ICD9 diagnosis codes from the database 214 as well as titles of documents related to established diagnoses and associated URLs from the unstructured data source 246. That is, assume the query requests patient diagnosis codes and URLS for documents related to the diagnosis codes included in patient medical records. Thus, which diagnosis codes are found in the database will not be known in advance of running the query. The abstract query 240 includes result fields 242 for which data from the database 214 and the unstructured data source 246 is to be returned in a corresponding result set 290 to the application 220. For example, a query could request that patient ID, ICD9 code and related documents and document URLs be returned. Note, however, from the user's perspective, the user simply includes the desired fields in the query, either as result fields or as part of a query condition.

In one embodiment, only a portion of the result fields 242 corresponds to logical fields defined by the data abstraction model 232. More specifically, only the result fields relating to data in the database 214 correspond to logical fields defined by the data abstraction model 232, while result fields relating to data of the unstructured data source 246 are not defined by corresponding logical fields. For instance, in the given example only the patient ID and ICD9 result fields correspond to logical fields defined by the data abstraction model 232. However, the ICD9 code related documents and document URLs result fields which relate to information in the unstructured data source 246 are not defined by the data abstraction model 232, as described in more detail below with reference to FIG. 3B.

As shown, the abstract query 240 also includes one or more query conditions 244 used to determine which data elements from database 214 and/or the unstructured data source 246 should be returned for the result fields 242. For instance, assume that in the given example the patient ID, ICD9 code, related and documents and/or URL information should only be returned for patients for which a corresponding diagnosis was established in 2005 and who have a Hemoglobin test value below “10” (Hct % Bld <‘10’). However, it should be noted that the conditions 244 are merely illustrated by way of example. In other words, abstract queries without conditions are contemplated.

As noted above, according to one aspect, the user may interact with user interface 210 to compose abstract query 240. To this end, the user interface 210 may display a suitable graphical user interface (GUI) screen for composing abstract query 240. For instance, a GUI screen can be configured to display a plurality of user-selectable elements, each representing a logical field of the data abstraction model 232 that may be selected to include in the set of result fields 242. For example, a variety of different GUI screen displays could show the “patient ID”, “ICD9”, “Hct % Bld”, “Diagnosis Year” and other logical fields as user-selectable elements that may be included in the set of result fields 242. Furthermore, in one embodiment, a user-selectable element of the graphical user interface may be clicked to extend a query result from a structured data source (e.g., a relational database) with information related to the query results available from unstructured data sources. For instance, in the given example the user-selectable element of the “ICD9” field can be associated with a checkbox that can be clicked to request related documents and/or associated URLs is retrieved from the unstructured data source 246 and returned with the query results. Furthermore, information from the unstructured data source 246 may be associated with the data from the structured data source. Continuing with the example given above, documents and or URLs related to a particular diagnosis code may be linked with that diagnosis code in query result set 290.

The GUI screen displayed in the user interface 210 may also display graphical elements allowing users to specify a query condition 244 using a logical field of the data abstraction model 232. However, using a GUI to specify the abstract query 240 is merely described by way of example and not meant to be limiting of the invention. In other words, any possible technique for composing abstract query 240 is broadly contemplated.

In one embodiment, the runtime component 234 generates an executable query for the abstract query 240 that is configured to retrieve the result set 290. More specifically, runtime component 234 may be configured to generate an executable query that includes a reference to a temporary result 275 in database 214. The temporary result 275 may be populated with unstructured data from the unstructured data source 246.

However, what unstructured data that needs to be retrieved from the unstructured data source 246 for the temporary result 275 may depend on what structured data is to be retrieved from the database 214. Accordingly, the runtime component 234 may be configured to identify a set of structured data from the database 214 and use this information to identify the unstructured data to include in the query result. In one embodiment, query execution unit 254 may generate and execute an initial database query to create a first temporary structured result set. The first temporary structured result set is then used to access the unstructured data source 246 to retrieve the corresponding unstructured data. For example, some of the results of the first query may be used as search terms for a keyword search of an unstructured database. The results of the search of unstructured data are then used to create a second temporary structured result set, which may be linked to the database 214.

In one embodiment, query execution unit 254 may be configured to create instance of a table resolver object 270. The table resvolver object may be configured to retrieve unstructured data from the unstructured data source 246 and to generate the second temporary structured result set. However, as noted above, different types of data included with the unstructured data source 246 are broadly contemplated. Accordingly, various different table resolver object types can be used to retrieve the unstructured data. Different exemplary resolver types are described in more detail in the commonly owned co-pending application, entitled “SYSTEM AND METHOD FOR CREATING AND POPULATING DYNAMIC, JUST IN TIME, DATABASE TABLES” (Attorney Docket No. ROC920060100US1), which is hereby incorporated herein in its entirety.

More generally, the table resolver object 270 may include methods for (1) initializing an instance of the table resolver object 270, (2) generating a temporary result, and (3) removing or cleaning-up the temporary result once it is no longer needed (i.e., after a query has been executed). For instance, in one embodiment the table resolver object 270 provides an initialization method for initializing temporary result 275. For example, the initialization method may be configured to determine whether the unstructured data source 246 exists and, if so, whether a database or network connection is required to access the unstructured data source 246. If so, the initialization method can further be configured to establish the required database or network connection. The specific actions required to initialize the table resolver object 270 (if any) will typically depend on the particular implementation. Generally however, the initialization method allows the table resolver object 270 to perform any actions that need to be performed only once for an instance of the object.

The table resolver 270 may further include a table generation method configured to generate the second temporary structured result set in tabular form and to link the second temporary structured result set with data in the database 214. An exemplary method for generating the second temporary structured result set using the corresponding unstructured data from the unstructured data source 246 is described in the commonly owned co-pending application, entitled “SYSTEM AND METHOD FOR CREATING AND POPULATING DYNAMIC, JUST IN TIME, DATABASE TABLES” (Attorney Docket No. ROC920060100US1), which is hereby incorporated herein in its entirety.

The table resolver 270 may further include a removal method that is configured to remove the second temporary structured result set after query execution. In one embodiment, the generation method may be further configured to generate a reference that may be used to identify a particular temporary result; such a reference may be passed between components of the query executing unit 254.

After the second temporary result set and is generated and stored as temporary result 275, the runtime component 234 may include a reference to the database 214 and the temporary result 275 with the executable query that is generated for the abstract query 240. This executable query may then be executed against the database 214 and the temporary result 275 such that data defining the result set 290 can be retrieved.

An exemplary embodiment for generating the executable queries and for generating the temporary result 275 using data from the database 214 and/or the unstructured data source 275 is described in greater detail below.

In one embodiment, the executable query corresponding to the abstract query 240 is submitted to the query execution unit 254 for execution. The query execution unit 254 uses the query engine 256 to execute the executable query against the database 214 and the linked temporary result 275. As shown, the query execution unit 254 includes only the query engine 256 for query execution, for simplicity. However, the query execution unit 254 may include other components, such as a query parser and a query optimizer. A query parser is generally configured to accept a received query input from a requesting entity, such as the application(s) 220, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 214), an underlying system on which the search strategy will be executed (e.g., computer system 110 of FIG. 1), and/or optional user specified optimization goals. In general such search strategies determine an optimized use of available hardware/software components to execute a query. Once an access plan is selected, the query engine 256 then executes the query according to the access plan.

When executing the executable query against the database 214 and the temporary result 275, the query engine 256 identifies each data record of the database 214 and the temporary result 275 that satisfies the abstract query 240. Each identified data record is included with the result set 290. The result set 290 is then returned to the application(s) 220.

In one embodiment, when the result set 290 is returned to the application(s) 220, the temporary result 275 having unstructured data from the unstructured data source 246 is removed from the database 214. Alternatively, the temporary result 275 is removed from the database 214 when the application(s) 220 is terminated. In other words, the temporary result 275 is dynamically generated in and removed from the database 214 and, therefore, also referred to as “dynamic table” hereinafter. However, other implementations are possible. For instance, the temporary result 275 can be stored persistently as part of the database 214. This may be useful for research circumstances where results often need to be saved for record keeping and tracking. Similarly, other optimizations could be achieved in some cases by avoiding using the unstructured search again for the same values unless the user specifically requests it.

### Logical/Runtime View of Environment

FIGS. 3A-3B show an illustrative relational view of software components, according to one embodiment of the invention. According to one aspect, the software components are configured for managing query execution. The software components include application 220, data abstraction model 232, runtime component 234, database 214 and unstructured data source 246 of FIG. 2. As shown, the database 214 includes a plurality of exemplary physical data representations 214₁, 214₂, . . . 214_{N} and the temporary result 275.

As noted above with reference to FIG. 2, the application 220 issues the abstract query 240 against the database 214 and the unstructured data source 246. In one embodiment, the application 220 issues the query 240 as defined by a corresponding application query specification 222. In other words, the abstract query 240 is composed according to logical fields rather than by direct reference to underlying physical data entities in the database 214. The logical fields are defined by the data abstraction model 232 which generally exposes information as a set of logical fields that may be used within a query (e.g., the abstract query 240) issued by the application 220 to specify criteria for data selection and specify the form of result data returned from a query operation. Furthermore, the abstract query 240 may include a reference to an underlying model entity that specifies the focus for the abstract query 240. In one embodiment, the application query specification 222 may include both criteria used for data selection (selection criteria 304; e.g., conditions 244 of FIG. 2) and an explicit specification of the fields to be returned (return data specification 306; e.g., result fields 242 of FIG. 2) based on the selection criteria 304, as illustrated in FIG. 3B.

The logical fields of the data abstraction model 232 are defined independently of the underlying data representation (i.e., one of the plurality of exemplary physical data representations 214_{1-N}) being used in the database 214, thereby allowing queries to be formed that are loosely coupled to the underlying data representation. More specifically, a logical field defines an abstract view of data whether as an individual data item or a data structure in the form of, for example, a database table. As a result, abstract queries such as the query 240 may be defined that are independent of the particular underlying data representation used. Such abstract queries can be transformed into a form consistent with the underlying physical data representation 214_{1-N} for execution against the database 214. By way of example, the abstract query 240 is translated by the runtime component 234 into an executable query which is executed against the database 214 to determine a corresponding result set (e.g., result set 290 of FIG. 2) for the abstract query 240.

In one embodiment, illustrated in FIG. 3B, the data abstraction model 232 comprises a plurality of field specifications 308₁, 308₂, 308₃, 308₄, 308₅ and 308₆ (six shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆ (collectively, field name 320) and an associated access method attribute 322₁, 322₂, 322₃, 322₄, 322₅, 322₆ (collectively, access methods 322). Each attribute may have a value. For example, logical field name attribute 320₁ has the value “Patient ID” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “Patientinfo” and data location metadata “Column” has the value “patient_ID”. Accordingly, assuming an underlying relational database schema in the present example, the values of data location metadata “Table” and “Column” point to a table “Patientinfo” having a column “patient_ID”.

In one embodiment, groups (i.e. two or more) of logical fields may be part of categories. Accordingly, the data abstraction model 232 includes a plurality of category specifications 310₁ and 310₂ (two shown by way of example), collectively referred to as the category specifications. In one embodiment, a category specification is provided for each logical grouping of two or more logical fields. For example, logical fields 308₁₋₂ and 308₃₋₆ are part of the category specifications 310₁ and 310₂, respectively. A category specification is also referred to herein simply as a “category”. The categories are distinguished according to a category name, e.g., category names 330₁ and 330₂ (collectively, category name(s) 330). In the present illustration, the logical fields 308₁₋₂ are part of the “Patient” category and logical fields 308₃₋₆ are part of the “Diagnoses” category.

The access methods 322 generally associate (i.e., map) the logical field names to data in the database (e.g., database 214 of FIG. 2). As illustrated in FIG. 3A, the access methods associate the logical field names to a particular physical data representation 214_{1-N} in the database. By way of illustration, two data representations are shown in the database 214, an XML data representation 214, and a relational data representation 214₂. However, the physical data representation 214_{N} indicates that any other data representation, known or unknown, is contemplated. In one embodiment, a single data abstraction model 232 contains field specifications (with associated access methods) for two or more physical data representations 214_{1-N}. In an alternative embodiment, a different single data abstraction model 232 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁ and 308₄₋₆ exemplify simple field access methods 322₁, 322₄, 322₅, and 322₆, respectively. The field specification 308₂ exemplifies a filtered field access method 322₂. The field specification 308₃ exemplifies a composed field access method 322₃.

Simple fields can be mapped directly to a particular entity in the underlying physical representation (e.g., a field mapped to a given database table and column) of the database 214. By way of illustration, as described above, the simple field access method 322₁ shown in FIG. 3B maps the logical field name 320₁ (“Patient ID”) to a column named “patient_ID” in a table named “Patientinfo”.

Filtered fields identify an associated physical entity and provide filters used to define a particular subset of items within the physical representation. An example is provided in FIG. 3B in which the filtered field access method 322₂ maps the logical field name 320₂ (“Street”) to a physical entity in a column named “street” in the “Patientinfo” table and defines a filter for individuals in the city of “NY”. Another example of a filtered field is a New York ZIP code field that maps to the physical representation of ZIP codes and restricts the data only to those ZIP codes defined for the state of New York.

Composed access methods compute a logical field from one or more physical fields using an expression supplied as part of the access method definition. In this way, information which does not exist in the underlying physical data representation may be computed. In the example illustrated in FIG. 3B the composed field access method 322₃ maps the logical field name 320₃ “Normalized Results” to “Hct % Bld/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 232 shown in FIG. 3B are representative of logical fields mapped to data represented in the relational data representation 214₂ shown in FIG. 3A. However, other instances of the data abstraction model 232 map logical fields to other physical representations, such as XML.

An illustrative abstract query corresponding to the abstract query 240 shown in FIG. 3B is shown in Table I below. By way of illustration, the illustrative abstract query is defined using XML. However, other languages may be used.

TABLE I
ABSTRACT QUERY EXAMPLE

```
001 <?xml version=“1.0”?>
002 <!--Query string representation: (Tumor Size = ’25.0’-->
003 <QueryAbstraction>
004 <Selection>
005 <Condition internalID=“4”>
006 <Condition field=“Hct%Bld” operator=“LT” value=“10”
007 internalID=“1”/>
008 <Condition internalID=“6”>
009 <Condition field=“Diagnosis Year” operator=“EQ”
              value=“2005”
010 internalID=“1”/>
011 </Selection>
012 <Results>
013 <Field name=“Patient ID”/>
014 <Field name=“ICD9”/>
015 <Unstructured Data name=“Diagnosis related documents
              and URLs”/>
016 </Results>
017 </QueryAbstraction>
```

Illustratively, the abstract query shown in Table I includes a selection specification (lines 004-011) containing selection criteria and a results specification (lines 012-017). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. It should be noted that the results specification in Table I includes two references (lines 015-016 of Table I) to unstructured data (“Unstructured data” in line 015) that is derived from an unstructured data source (e.g., unstructured data source 246 of FIG. 2).

An illustrative data abstraction model (DAM) corresponding to the data abstraction model 232 shown in FIG. 3B is shown in Table II below. By way of illustration, the illustrative Data Abstraction Model is defined using XML. However, other languages may be used.

TABLE II
DATA ABSTRACTION MODEL EXAMPLE

001 <?xml version=“1.0”?>
002 <DataAbstraction>
003 <Category name=“Patient”>
004 <Field queryable=“Yes” name=“Patient ID” displayable=“Yes”>
005 <AccessMethod>
006 <Simple attrName=“patient_ID ” entityName=“Patientinfo”></Simple>
007 </AccessMethod>
008 </Field>
009 <Field queryable=“Yes” name=“Street” displayable=“Yes”>
010 <AccessMethod>
011 <Filter attrName =“street” entityName =“Patientinfo”
012 Filter=”Patientinfo.city=NY”> </Filter>
013 </AccessMethod>
014 </Field>
015 </Category>
016 <Category name=“Diagnoses”>
017 <Field queryable=“Yes” name=“Normalized Results” displayable=“Yes”>
018 <AccessMethod>
019 <Composed attrName =“Results” entityName =“Hct%Bld”
020 Expression=” attrName /10”> </Composed>
021 </AccessMethod>
022 </Field>
023 <Field queryable=“Yes” name=“Hct%Bld” displayable=“Yes”>
024 <AccessMethod>
025 <Simple attrName =“Results” entityName =“Hct%Bld”></Simple>
026 </AccessMethod>
027 </Field>
028 <Field queryable=“Yes” name=“Diagnosis Year” displayable=“Yes”>
029 <AccessMethod>
030 <Simple attrName =“Tests” entityName =“year”></Simple>
031 </AccessMethod>
032 </Field>
033 <Field queryable=“Yes” name=“ICD9” displayable=“Yes”>
034 <AccessMethod>
035 <Simple attrName =“Tests” entityName =“diagnosis”></Simple>
036 </AccessMethod>
037 </Field>
038 </Category>
039 </DataAbstraction>

By way of example, note that lines 009-014 correspond to the field specification 308₂ of the DAM 232 shown in FIG. 3B and lines 033-037 correspond to the field specification 308₆.

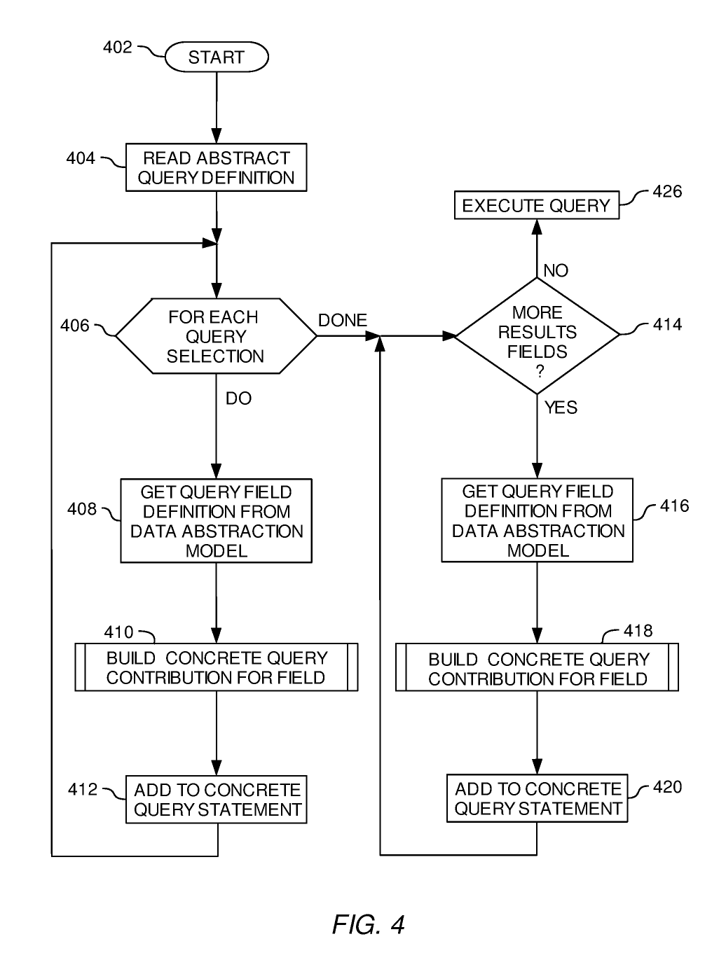

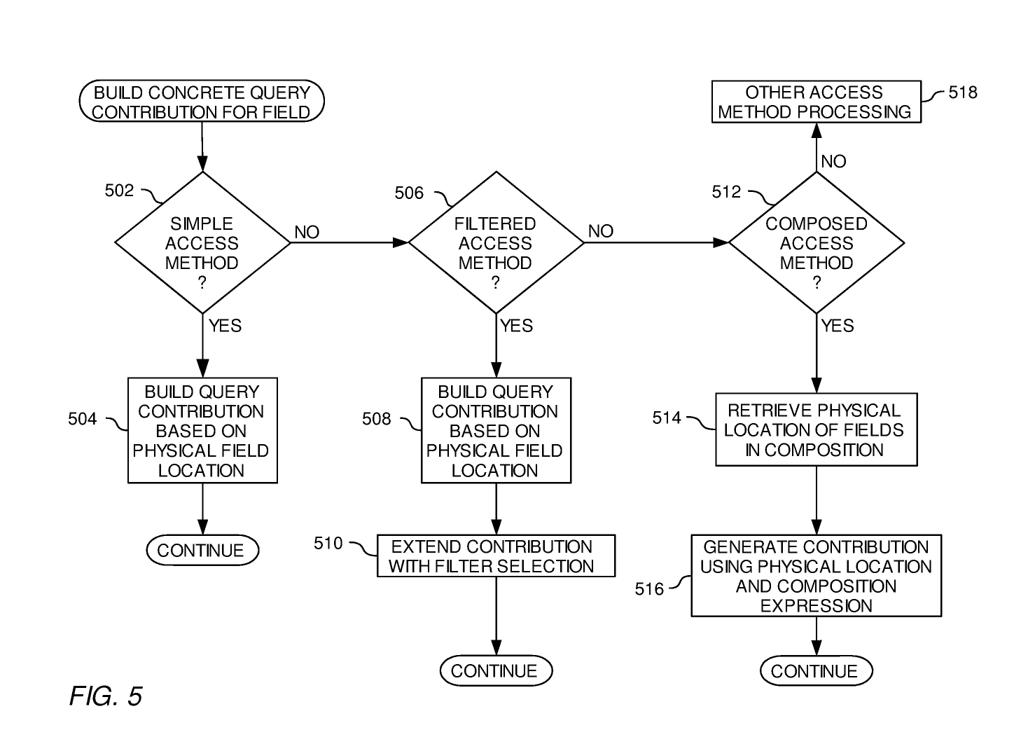

An executable query may be generated from the abstract query of Table I and executed against an underlying database (e.g., database 214 of FIG. 3A) having one or more temporary results (e.g., temporary result 275 of FIG. 3A). An exemplary method for generating an executable query from an abstract query is described below with reference to FIGS. 4-5.

### Generating an Executable Query from an Abstract Query

FIG. 4 illustrates a method 400 for generating an executable query (also referred to hereinafter as “concrete” query) from an abstract query (e.g., abstract query 240 of FIG. 2) using the runtime component 234 of FIG. 2. The method 400 begins at step 402 when the runtime component 234 receives the abstract query (such as the abstract query shown in Table I). At step 404, the runtime component 234 parses the abstract query and locates selection criteria (e.g., conditions 244 of FIG. 2) and result fields (e.g., result fields 242 of FIG. 2).

At step 406, the runtime component 234 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 234 uses the field name from a selection criterion of the abstract query to look up the definition of the field in the data abstraction model 232. As noted above, the field definition includes a definition of the access method used to access the data structure associated with the field. The runtime component 234 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 234 identifies the information to be returned as a result of query execution. As described above, in one embodiment, the abstract query defines a list of result fields, i.e., a list of logical fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 234 looks up a result field name (from the result specification of the abstract query) in the data abstraction model 232 and then retrieves a result field definition from the data abstraction model 232 to identify the physical location of data to be returned for the current logical result field. The runtime component 234 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 426, where the concrete query is executed.

In one embodiment, when steps 414 to 420 are performed for a result field present in the abstract query, the runtime component 294 may generate a concrete query contribution that is configured to retrieve data from a temporary result linked to the database 214 (e.g., the results of an unstructured search linked to database 214 by one of the methods provided by table resolver 270). Specifically, such concrete query contributions can be generated for references to unstructured data that is derived from an unstructured data source, such as the references in lines 015 and 016 of Table I. In one embodiment, the temporary result is generated and stored in the database 214 prior to generating concrete query contributions. Thus, the concrete query contribution can be built based on the data location for the temporary result, not based on the original unstructured data source. Processing then continues according to method 400 as described above. An exemplary method for generating a concrete query that references data contained in a temporary data structure from an underlying abstract query is described in the commonly owned co-pending application, entitled “SYSTEM AND METHOD FOR CREATING AND POPULATING DYNAMIC, JUST IN TIME, DATABASE TABLES” (Attorney Docket No. ROC920060100US1), which is hereby incorporated herein in its entirety.

FIG. 5 illustrates a method 500 for building a concrete query contribution for a logical field according to steps 410 and 418 of FIG. 4. At step 502, the query engine 256 of FIG. 2 determines whether the access method associated with the current logical field is a simple access method. If so, a concrete query contribution is built (step 504) based on the physical data location information for an existing database table and processing then continues according to method 400 described above.

If it is determined at step 502 that the access method associated with the current logical field is not a simple access method, processing continues to step 506 where the query engine 256 determines whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the query engine 256 determines whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Managing Query Execution

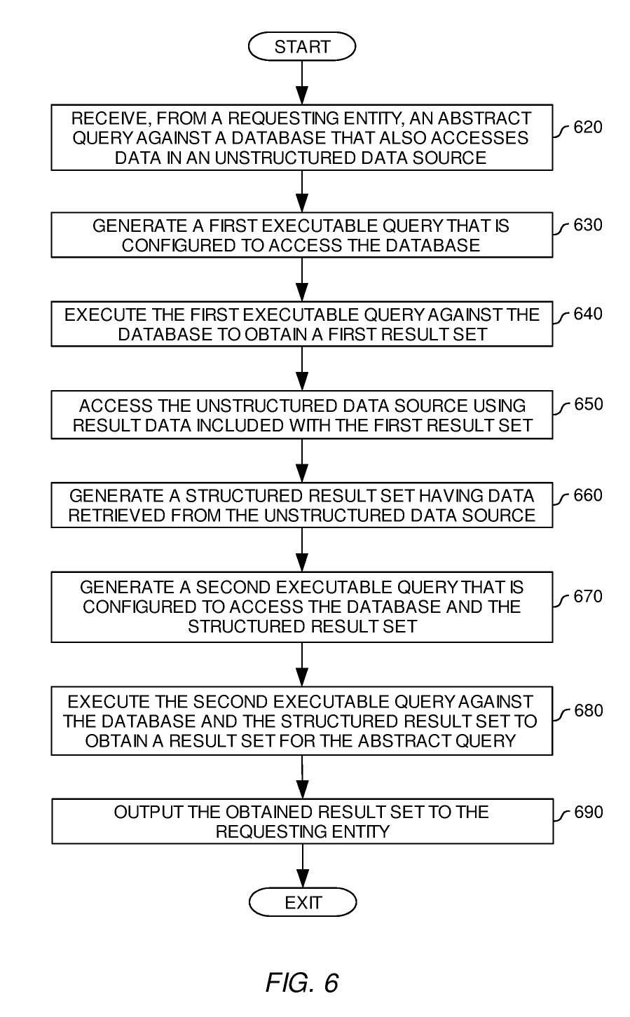

FIG. 6 illustrates an embodiment of a method 600 for executing an abstract query. In one embodiment, some of the steps of method 600 are performed by the runtime component 234 and/or the query execution unit 254 of FIG. 2.

Method 600 starts at step 620, where an abstract query is received from a requesting entity. The abstract query may be configured to be executed against an underlying database (e.g., database 214 of FIG. 2) and an unstructured data source (e.g., unstructured data source 246 of FIG. 2). In one embodiment, the abstract query is received from a user using the user interface 210 of FIG. 2. By way of example, assume that the exemplary abstract query of Table I is received. As was noted above, the exemplary abstract query of Table I is configured to retrieve patient ID, ICD9 codes, and related document and/or document URLs for patients with a diagnosis defined by an ICD9 code was established in 2005 and who have had a Hemoglobin test value below “10” (Hct % Bld <‘10’).

At step 630, a first executable query is generated for accessing data from the database described by the data abstraction model (e.g., data abstraction model of Table II above). In one embodiment, the first executable query is generated on the basis of the received abstract query. More specifically, the first executable query can be generated on the basis of each result field (e.g., result fields 242 of FIG. 2) and each query condition (e.g., conditions 244 of FIG. 2) having a condition field that relates to a logical field in the underlying data abstraction model. The first executable query is used to retrieve a set of structured data from the database that may then be used to retrieve unstructured data from the unstructured data source. Accordingly, in the given example, the first executable query may be configured to identify ICD9 diagnosis codes from the underlying database so that related documents and/or URLs may be retrieved from the unstructured data source.

Assume now that the SQL query of Table III below is generated as the first executable query. Note, however, that the concrete query is defined in SQL for purposes of illustration. For instance, persons skilled in the art will readily recognize corresponding XML representations, such as used to describe the exemplary abstract query of Table I.

TABLE III
CONCRETE QUERY EXAMPLE

```
001 SELECT DISTINCT
002 “t1”.“PATIENT_ID” AS “Patient ID”,
003 “t2”.“ICD9” AS “ICD9”,
004 FROM
005 “DBSAMPL”.“PATIENTINFO” “t1”.
006 LEFT OUTER JOIN “DBSAMPL”. “TESTS” “t2”
        ON “t1”.“PATIENT_ID”
007 =“t2”. “PATIENT_ID”
008 LEFT OUTER JOIN (SELECT
009 CAST(“t3”. “NUMERIC_VALUE” AS
                        DECIMAL (15 , 3))
010 AS “Hct % Bld”,
011 “t3”. “PATIENT_ID”
012 FROM
013 “DBSAMPL”. “RESULTS” “t3”
014 WHERE
015 “t3”.“LOINC CODE” = ‘20570-8’ ) “t3”
016 ON “t1”.“PATIENT_ID” =
                        “t3”.“PATIENT_ID”
017 WHERE
018 ( ( “t3”.“Hct % Bld” < 10 AND “t2”.“YEAR” = ‘2005’)
019 AND “t1”.“AUTHORIZATION_ID1” IS NULL)
```

In this example, the results specification in lines 002-003 and the selection criteria in line 018 correspond to the results specification in lines 013-014 and the selection criteria in lines 005-010 of the exemplary abstract query of Table I, respectively. Accordingly, the exemplary first executable query of Table III is configured to retrieve patient identifiers (line 002) and ICD9 codes (line 003) for patients having had a diagnosis corresponding to the respective ICD9 code that was established in the year 2005 (line 018) with a Hemoglobin test value less than 10 (line 018).

By way of example, the query shown in Table III includes a concrete query contribution for each result field and for each query condition field relating to a logical field in the underlying data abstraction model. However, as noted above, in one embodiment only result and/or condition fields for which extension of data retrieval to the unstructured data source was requested (as described above with reference to FIG. 2) are included with the first executable query. In other words, the first executable query can be configured to retrieve only ICD9 codes from the underlying database to allow a subsequent search on the unstructured data source as described above.

At step 640, the first executable query is executed against the underlying database to determine a first structured result set. In one embodiment, the first structured result set is stored as a first temporary result (e.g., temporary result 275 of FIG. 2) in the underlying database. Assume now that the result set illustrated in Table IV below is created.

TABLE IV
FIRST RESULT TABLE EXAMPLE

| 001 | Patient ID | ICD9 |
|---|---|---|
| 002 | 5084 | 001.9 |
| 003 | 5553 | 280.0 |
| 004 | 5054 | 280.9 |
| 005 | 5622 | 280.9 |
| 006 | 5727 | 288.9 |

The exemplary first temporary result of Table IV illustratively includes information for five different patients (lines 002-006). More specifically, in the given example only for the patients having the patient identifiers “5084”, “5553”, “5054”, “5622” and “5727” (lines 002-006) a corresponding diagnosis defined by a respective ICD9 code was established in 2005 and a recently determined Hemoglobin test value was below “10” (line 018 of the exemplary first executable query of Table III). Note that only four different diagnoses were established for the five patients that are represented by the ICD9 codes “001.9” (line 002), “280.0” (line 003), “280.9” (lines 004-005) and “288.9” (line 006).

At step 650, the unstructured data source is accessed using at least a portion of the first structured result set. In the given example, the unstructured data source is accessed using the ICD9 codes indicated in lines 002-006 of Table IV. In one embodiment, expansions and search terms are applied to each of the used ICD9 diagnosis codes or related metadata. For instance, with respect to the retrieved ICD9 code 001.9 (line 002 of Table IV), any Cholera related ICD9 values such as 001.0, 001.1, 001.9 or text values such as ‘cholera’, ‘vibrio cholerae’, ‘vibrio cholerae el tor’ can be used. Thus, unstructured data related to at least a portion of the ICD9 codes indicated in lines 002-006 of Table IV can be retrieved from the unstructured data source.

At step 660, a second structured result set is generated using the unstructured data retrieved from the unstructured data source at step 650. In one embodiment, the second structured result set is stored as a second temporary result (e.g., temporary result 275 of FIG. 2) in the underlying database. As noted above, in the given example the first temporary result can be deleted when the second temporary result is stored. More specifically, the first temporary result can be overwritten by the second temporary result.

By way of example, assume that the second structured result set is generated in tabular form and stored as a database table named “Resolved table” in the underlying database. Assume further that the “Resolved table” illustrated in Table V below is created.

TABLE V
RESOLVED TABLE EXAMPLE

| 001 | ICD9 | Related document |
|---|---|---|
| 002 | 001.9 | Impact of Diet on Cholera related illnesses |
| 003 | 001.9 | Cholera and You. Way's not to get it. |
| 004 | 001.9 | Cholera in the free Internet encyclopedia |
| 005 | 280.0 | Iron-Deficiency Anemia-Blood Diseases & Disorders |
| 006 | 280.9 | Anemia - Symptoms, Treatment and Prevention |
| 007 | 288.9 | ScienceDaily: Gene Patterns In White Blood Cells . . . |
| 008 | 288.9 | Introduction to Hematology: What is Blood? Diseases |
| | | of White . . . |

| 001 | document URL |
|---|---|
| 002 | http://www.medical.com/cholera/doc1.pdf |
| 003 | http://www.docSRus.com/selfhelp/cholera.html |
| 004 | http://en.encyclopedia.org/Cholera |
| 005 | http://www.umm.edu/blood/aneiron.htm |
| 006 | http://www.healthscout.com/ency/407/112/main.html |
| 007 | http://www.sciencedaily.com/releases/2006/02/060220102239.htm |
| 008 | http://www.psbc.org/hematology/02_wbc_diseases.htm |

The “Resolved table” includes information related to each one of the ICD9 codes identified in the exemplary first temporary result of Table IV. This information is arranged in three columns (line 001) and includes “ICD9” codes, a “Related document” column and a “document URL” column. Note that for the first identified ICD9 code “001.9” in line 002 of Table IV three different documents having associated URLs (lines 002-004 of Table V) are retrieved from the unstructured data source. For the ICD9 code “280.0” in line 003 of Table IV only a single document having an associated URL (line 005 of Table V) is retrieved. For the ICD9 code “280.9” in lines 004-005 of Table IV also only a single document having an associated URL (line 006 of Table V) is retrieved. For the ICD9 code “288.9” in line 006 of Table IV, however, two documents having associated URLs (lines 007-008 of Table V) are retrieved.

In one embodiment, generating the second structured result set and storing it as a temporary result in the underlying database includes generating database relations to one or more tables in the underlying database. In the given example, the ICD9 codes used to retrieve the unstructured data from the unstructured data source are retrieved (line 003 of Table III) from a “Tests” table in the underlying database “DBSAMPL” (line 006-007 of Table III). Accordingly, the example “Resolved table” can be stored in the “DBSAMPL” database and linked to the “Tests” table via the ICD9 codes.

At step 670, a second executable query is generated for accessing the underlying database and the second temporary result. The second executable query is configured to retrieve data from the database and the second temporary result that satisfies the conditions specified in the original abstract query. Accordingly, in one embodiment the second abstract query is generated from the received abstract query as described above with reference to FIGS. 4 and 5. However, generating a query that queries the underlying database and the second temporary result is merely described by way of example and not limiting of the invention. More specifically, in the given example the first temporary result already includes all information from the database that is required for execution of the received abstract query. Accordingly, instead of executing the second executable query against the complete underlying database and the second temporary result, it may simply be executed against the first and second temporary results.

Assume now that the exemplary SQL query of Table VI below is generated as the second executable query. In one embodiment, the transformation of the received abstract query to the exemplary SQL query of Table VI is performed as described above with reference to FIGS. 4-5. However, it should be noted that the exemplary concrete query is defined in SQL for purposes of illustration and not for limiting the invention. For instance, persons skilled in the art will readily recognize corresponding XML representations, such as used to describe the exemplary abstract query of Table I. Therefore, all such different implementations are broadly contemplated.

TABLE VI
CONCRETE QUERY EXAMPLE

```
001 SELECT DISTINCT
002 “t1”.“PATIENT_ID” AS “Patient ID”,
003 “t2”.“ICD9” AS “ICD9”,
004 “t4”.“Related document” AS “Diagnosis related documents”,
005 “t4”.“document URL” AS “Document URLs”,
006 FROM
007 “DBSAMPL”.“PATIENTINFO” “t1”.
008 LEFT OUTER JOIN “DBSAMPL”. “TESTS” “t2” ON
          “t1”.“PATIENT_ID”
009 =“t2”. “PATIENT_ID”
010 LEFT OUTER JOIN PluginTable41 “t4” ON
        “t2”.“ICD9” = “t4”. “ICD9”
011 LEFT OUTER JOIN (SELECT
012 CAST(“t3”. “NUMERIC_VALUE” AS
                      DECIMAL (15 , 3))
013 AS “Hct % Bld”,
014 “t3”. “PATIENT_ID”
015 FROM
016 “DBSAMPL”. “RESULTS” “t3”
017 WHERE
018 “t3”.“LOINC CODE” = ‘20570-8’ ) “t3”
019 ON “t1”.“PATIENT_ID” =
                      “t3”.“PATIENT_ID”
020 WHERE
021 ( ( “t3”.“Hct % Bld” < 10 AND “t2”.“YEAR” = ‘2005’)
022 AND “t1”.“AUTHORIZATION_ID1” IS NULL)
```

Note that the exemplary second executable query of Table VI essentially corresponds to the exemplary first executable query of Table III above, wherein lines 004-005 and 010 were added to retrieve the requested diagnosis related documents and associated URLs according to lines 015-016 of the exemplary abstract query of Table I. As noted above, the exemplary second executable query of Table VI includes a reference to the “Resolved table” (line 010) that was generated at step 660.

At step 680, the second executable query is executed against the underlying database and the second temporary result. In the given example, the exemplary concrete query of Table VI is executed against the “Patientinfo”, “Test” and “Results” tables of the underlying “DBSAMPL” database (lines 007-019 of Table VI) and the exemplary “Resolved table” of Table V (line 010 of Table VI). Thus, a query result (e.g., result set 290 of FIG. 2) for the received abstract query of Table I is obtained. For brevity, the obtained query result is not described in more detail. However, it should be noted that the obtained query result in the given example corresponds to a merge of the exemplary first and second temporary results of Tables IV and V. At step 690, the obtained query result is returned to the requesting entity. Processing then exits.

While the foregoing is directed to embodiments of the present invention, other and further embodiments of the invention may be devised without departing from the basic scope thereof, and the scope thereof is determined by the claims that follow.

What is claimed is:

1. A computer-implemented method of retrieving data from a database and an unstructured data source, comprising:
accessing the database to retrieve a first structured result set;
accessing the unstructured data source using at least a portion of the structured data included in the first structured result set to retrieve an unstructured data result set; and
generating a second structured result set from the unstructured data result set; and
storing the second structured result set, wherein the second structured result set is available for further query processing.

2. The method of claim 1, wherein accessing the database to retrieve the first structured result set comprises executing a first query against the database.

3. The method of claim 2, wherein the first query is generated on the basis of a query issued from a requesting entity, and wherein the query issued from the requesting entity is configured to retrieve data from the database and the unstructured data source.

4. The method of claim 3, further comprising:
generating a second query, wherein the second query is configured to retrieve data from the database and the second structured result set;
executing the second query against the database and the second structured result set to obtain a query result for the query issued from the requesting entity; and
returning the obtained query result to the requesting entity.

5. The method of claim 1, further comprising, prior to accessing the database:
receiving, from a requesting entity, an abstract query of data contained in the database and the unstructured data source, wherein the abstract query is composed from logical fields of a data abstraction model abstractly describing the data in the database and wherein the abstract query includes a request to extend data results for the query retrieved from the database with data from the unstructured data source.

6. The method of claim 5, further comprising generating, using the received abstract query, an executable query capable of being executed by a query engine against the database; and wherein accessing the database to retrieve the structured data comprises executing the executable query against the database.

7. The method of claim 6, wherein the received abstract query includes at least one result field for which data is to be returned from the database; and wherein generating the executable query comprises:
including the at least one result field as a result field with the executable query.

8. The method of claim 6, wherein the received abstract query includes at least one condition field configured to select data to be returned from the database; and wherein generating the executable query comprises:
including the at least one condition field as a result field and as a condition field with the executable query.

9. The method of claim 5, further comprising:
generating, from the received abstract query, an executable query capable of being executed by a query engine against the database and the second structured result set;
executing the executable query against the database and the second structured result set to obtain a query result for the abstract query; and
returning the obtained query result to the requesting entity.

10. The method of claim 1, wherein the database includes one or more database tables and wherein storing the second structured result in the database comprises creating a temporary database table containing the retrieved unstructured data from the unstructured data source.

11. A computer-readable medium containing a program which, when executed by a processor, performs an operation for retrieving data from a database and an unstructured data source, the process comprising:
accessing the database to retrieve a first structured result set;
accessing the unstructured data source using at least a portion of the structured data included in the first structured result set to retrieve an unstructured data result set; and
generating a second structured result set from the unstructured data result set; and
storing the second structured result set, wherein the second structured result set is available for further query processing.

12. The computer-readable medium of claim 11, wherein accessing the database to retrieve the first structured result set comprises executing a first query against the database.

13. The computer-readable medium of claim 12, wherein the first query is generated on the basis of a query issued from a requesting entity, and wherein the query issued from the requesting entity is configured to retrieve data from the database and the unstructured data source.

14. The computer-readable medium of claim 13, wherein the operation further comprises:
generating a second query, wherein the second query is configured to retrieve data from the database and the second structured result set;
executing the second query against the database and the second structured result set to obtain a query result for the query issued from the requesting entity; and
returning the obtained query result to the requesting entity.

15. The computer-readable medium of claim 11, wherein the operation further comprise, prior to accessing the database:
receiving, from a requesting entity, an abstract query of data contained in the database and the unstructured data source, wherein the abstract query is composed from logical fields of a data abstraction model abstractly describing the data in the database and wherein the abstract query includes a request to extend data results for the query retrieved from the database with data from the unstructured data source.

16. The computer-readable medium of claim 15, wherein the operation further comprise generating, using the received abstract query, an executable query capable of being executed by a query engine against the database; and wherein accessing the database to retrieve the structured data comprises executing the executable query against the database.

17. The computer-readable medium of claim 16, wherein the received abstract query includes at least one result field for which data is to be returned from the database; and wherein generating the executable query comprises:
including the at least one result field as a result field with the executable query.

18. The computer-readable medium of claim 16, wherein the received abstract query includes at least one condition field configured to select data to be returned from the database; and wherein generating the executable query comprises:
including the at least one condition field as a result field and as a condition field with the executable query.

19. The computer-readable medium of claim 15, wherein the operation further comprise:
generating, from the received abstract query, an executable query capable of being executed by a query engine against the database and the second structured result set;
executing the executable query against the database and the second structured result set to obtain a query result for the abstract query; and
returning the obtained query result to the requesting entity.

20. The computer-readable medium of claim 11, wherein the database includes one or more database tables and wherein storing the second structured result in the database comprises creating a temporary database table containing the retrieved unstructured data from the unstructured data source.

21. A system, comprising:
a processor; and
a memory containing a program, wherein the program, when executed by the processor, is configured to:
in response to receiving a database query for execution:
access a database to retrieve a first structured result set,
access an unstructured data source using at least a portion of the structured data included in the first structured result set to retrieve an unstructured data result set,
generate a second structured result set from the unstructured data result set, and
store the second structured result set, wherein the second structured result set is available for further query processing.

22. The system of claim 21, wherein accessing the database to retrieve the first structured result set comprises executing a first query against the database.

23. The system of claim 22, wherein the first query is generated on the basis of a query issued from a requesting entity, and wherein the query issued from the requesting entity is configured to retrieve data from the database and the unstructured data source.

24. The system of claim 23, wherein the program is further configured to:
generate a second query, wherein the second query is configured to retrieve data from the database and the second structured result set;
execute the second query against the database and the second structured result set to obtain a query result for the query issued from the requesting entity; and
return the obtained query result to the requesting entity.
